(19) United States
(12) Patent Application Publication
(10) Pub. No.: US 2003/0168294 A1
(43) Pub. Date: Sep. 11, 2003

(54) Brake band and a method for forming the same

(76) Inventors: Yuji Fujii, Ann Arbor, MI (US); Ted Duane Snyder, Brighton, MI (US); Anthony Joseph Grzeslak, Sauk Village, IL (US)

Correspondence Address: CHUPA & ALBERTI, P.C., 31313 NORTHWESTERN HWY, SUITE 205, FARMINGTON HILLS, MI, 48334, US

(21) Appl. No.: 09/683,979

(22) Filed: Mar. 8, 2002

(51) Int. Cl. F16D 51/00

(52) U.S. Cl. 188/77 R; 188/77 W

(57) ABSTRACT

A brake band 12 which consistently provides substantially the same amount of braking force in response to a certain signal under either steady or varying band operating conditions, including varying oil flow rate into the band-drum interface, varying temperature, and varying drum rotational speed. Particularly, the brake band 12 has at least one groove 46 which is deployed upon the engagement surface 22 and an aperture 50 which is disposed upon a very end of 48 of the groove 46.

### BACKGROUND OF INVENTION

1. Field of the Invention

The present invention generally relates to a brake band and to a method for forming the same and more particularly, to a brake band which allows a vehicle to be selectively and smoothly shifted from one gear ratio to another in a consistent manner under varying band brake operating conditions.

2. Background of the Invention

A vehicular automatic transmission system typically comprises a band brake assembly which includes a brake band, a drum, and an actuator. The drum is typically mounted on a rotating component such as an automatic transmission shaft and is directly or indirectly connected to a gear set, such as to a planetary gear set which is often operatively positioned inside of the drum. The brake band selectively holds or releases the drum in order to alter an existing gear configuration and to achieve a desired gear ratio. That is, when it is desired to achieve a different gear ratio, the drum is selectively braked or slowed/stopped by the use of a brake band which selectively engages the outer surface of the drum. This process is often referred to as band engagement. Particularly the band-drum interface is lubricated with a transmission fluid (e.g., oil) prior to and during the band engagement, and the oil at the interface is squeezed out of the interface during the band engagement process.

While a conventional brake band does brake or slow/stop drum motion, it suffers from some drawbacks. For example and without limitation, the brake band does not consistently provide the same amount of braking torque in response to a certain torque request (or actuator output) under different band operating conditions, including varying amounts of oil flow into the band-drum interface, varying oil temperature, and varying drum rotational speed, thereby creating a variable braking torque profile. The variable braking torque profile during the band engagement leads to varying vehicle output shaft torque which causes inconsistent shift feel or undesirable vehicle vibration as the gear ratio is modified.

### SUMMARY OF INVENTION

It is a first non-limiting advantage of the present invention to provide a brake band which overcomes some or all of the previously delineated drawbacks associated with prior brake bands.

It is a second non-limiting advantage of the present invention to provide a brake band which overcomes some or all of the previously delineated drawbacks of prior brake bands by providing a substantially consistent amount of braking torque in response to substantially identical braking requests occurring under different band operating conditions, including varying amount of oil flow into the band-drum interface, varying oil temperature and varying drum rotational speed.

It is a third non-limiting advantage of the present invention to provide a method for forming a brake band which overcomes some or all of the previously delineated drawbacks of prior brake bands.

According to a first non-limiting aspect of the present invention, a brake band is provided and includes an engagement surface having at least one groove and an aperture which is positioned at the first end of the at least one groove, thereby allowing the brake band to consistently provide a desired amount of braking force.

According to a second non-limiting aspect of the present invention, a brake band is provided and includes an engagement surface having a first plurality of grooves which are disposed upon a certain axis and a second plurality of grooves which are disposed upon a certain second axis, the brake band further having a first plurality of apertures and a second plurality of apertures, each of the first plurality of apertures being disposed upon an end of a unique one of the first plurality of grooves and each of the second plurality of apertures being disposed upon an end of a unique one of the second plurality of grooves.

According to a third non-limiting aspect of the present invention, a method of forming a brake band is provided and comprises the steps of forming a generally planar member having a first and a second end, the generally planar member having a longitudinal axis of symmetry; forming a plurality of grooves within a surface of the first member; and forming an aperture within one end of each of the plurality of grooves.

These and other features, aspects, and advantages of the present invention will become apparent from a reading of the following detailed description of the preferred embodiment of the invention and by reference to the following drawings.

### BRIEF DESCRIPTION OF DRAWINGS

FIG. 1 is a side sectional view of a portion of a band brake assembly, including a brake band, a drum, and an actuator which is made in accordance with the teachings of the preferred embodiment of the invention;

FIG. 2 is sectional view of the portion of a conventional band brake assembly which is shown in FIG. 1 and which illustrates the flow of lubricant, such as oil, into the band-drum interface from the automatic transmission shaft;

FIGS. 3(a-b) are flattened bottom views of conventional brake bands;

FIG. 4 is a graphical illustration of band brake torque controllability and variability definitions;

FIGS. 5(a-b) are graphical illustrations the performance of the brake band which is shown in FIG. 3(a) and which are expressed by controllability and variability measurements;

FIG. 6 is a flattened bottom view a brake band which is made in accordance with the teachings of a first embodiment of the invention;

FIG. 7 is a side view of the brake band which is shown in FIG. 6 in combination with a rotating drum illustrating the flow of oil which occur during the band engagement;

FIG. 8 is a flattened bottom view a brake band which is made in accordance with the teachings of a second embodiment of the invention;

FIG. 9 is a flattened bottom view of a brake band which is made in accordance with the teachings of a third embodiment of the invention;

FIG. 10 is a flattened bottom view of a brake band which is made in accordance with the teachings of a fourth embodiment of the invention;

FIG. 11 is a flattened bottom view of a brake band which is made in accordance with the teachings of a fifth embodiment of the invention;

FIG. 12 is a flattened bottom view of a brake band which is made in accordance with the teachings of a sixth embodiment of the invention;

FIG. 13 is a flattened bottom view of a brake band which is made in accordance with the teachings of a seventh embodiment of the invention;

FIG. 14 is a flattened bottom view of a brake band which is made in accordance with the teachings of an eighth embodiment of the invention;

FIG. 15 is a flattened bottom view of a brake band which is made in accordance with the teachings of a ninth embodiment of the invention;

FIGS. 16(a-b) are graphs illustrating the performance of the brake band which is shown in FIG. 6;and

FIGS. 17(a-b) are graphs illustrating the performance of the brake band which is shown in FIG. 10.

### DETAILED DESCRIPTION

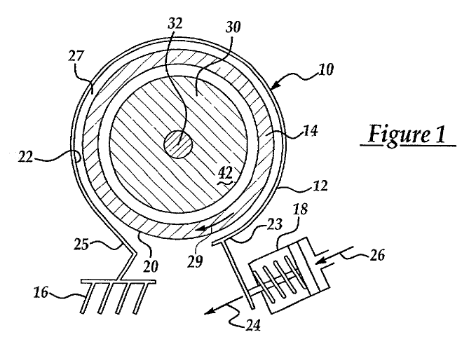

Referring now to FIG. 1, there is shown a part of an automatic vehicular transmission, including a band brake assembly 10 which operatively incorporates a brake band 12 which is made in accordance with the teachings of the preferred embodiment of the invention.

Particularly, band brake assembly 10 also includes a drum member 14 which is operatively disposed within a casing 16 and an actuator 18, such as and without limitation, a hydraulic actuator. As shown, the brake band 12 has a first end 23 which is coupled to the actuator 18 and a second opposed end 25 which is coupled the automatic transmission casing 16. Band brake assembly further houses several transmission components 30, such as a gear set, which are contained within the drum member 14 and which may selectively form several unique gear configurations through band engagement, effective to respectively provide several unique gear ratios. Drum member 14 is typically mounted to a rotating shaft 32 and is typically coupled to other automatic transmission components, such as component 30, which may include a gear set. These components, such as component 30, are further coupled to an output shaft (not shown) and, in this manner, selectively transfer some or substantially all of band braking torque to the output shaft during band engagement or during a change in the gear ratio. The output shaft (not shown) is coupled to the wheels of the vehicle (not shown), thereby allowing the vehicle to be selectively maneuvered.

Further, as shown, the brake band 12 resides about the periphery of the drum 14 and, as should be appreciated to those of ordinary skill in the art, the actuator 18 is selectively movable under a controlled amount of actuation force 26 from a first position (which is shown in FIG. 1) in which the brake drum 12 is remote from the outer surface 20 of the brake drum 14, to a second position (i.e., the actuator 18 moves in the direction of arrow 24) during the band engagement, causing the inner or engagement surface 22 of the brake band 12 to mechanically and frictionally engage the outer surface 20 of the drum 14.

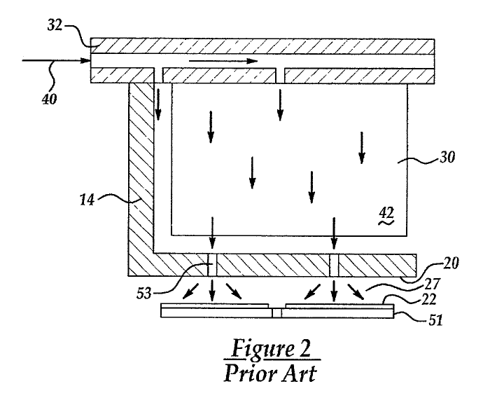

FIG. 2 shows a cross sectional view of a conventional band and drum assembly illustrating a conventional lubrication method. As shown best in FIG. 2, lubricating fluid or oil 40 is typically communicated into the interior 42 of the drum member 14 along the rotating shaft 32. The received oil 40 is made to lubricatingly contact the contained members, such as member 30, and is then communicated to the band-drum interface 27 or engagement surface 22 of the conventional brake band 51 through the drum lubrication holes 53 prior to and during the band engagement.

During the earlier stage of the band engagement (e.g., as the actuator 18 begins to move in the direction of arrow 24) a thin oil layer exists at the band-drum interface 27 and transmits braking force through viscous shear force before the band surface 22 makes a mechanical contact with the drum surface 20. The amount of this viscous shear force varies largely under different band operating conditions, including the amount of oil from the band-drum interface 27, oil temperature, and drum rotational speed. Thus, it is critical to consistently and efficiently remove the oil at the band-drum interface 27 during the band engagement in order to achieve a consistent brake torque profile. After the oil film is “squeezed out” of the interface 27, the brake force is transmitted through the mechanical contact between the band surface 22 and the drum surface 20.

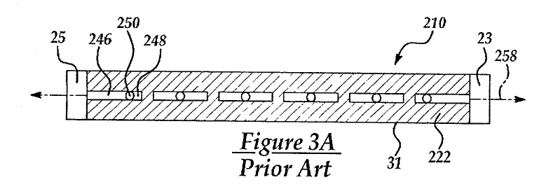

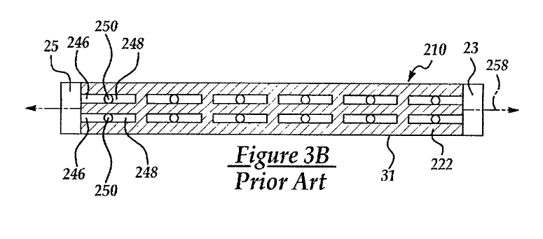

Referring now to FIGS. 3(a-b), there are shown conventional brake bands 210, commonly found in a conventional automatic transmission system. Each brake band 210 is formed from a thin steel strap 31 which is lined with a friction material 222 having grooves 246 and oil discharge holes 250. A groove 246 may be relatively straight, V-shaped, oblique or substantially any other geometry or configuration which may be desired. Oil discharge holes are typically positioned inside the grooves 246, away from groove ends 248, as shown in FIGS. 3(a-b).

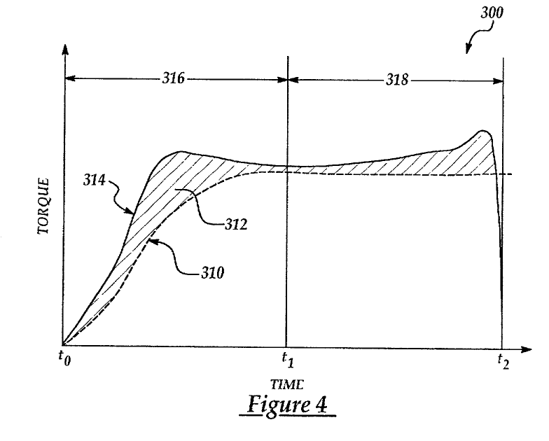

Referring now to FIG. 4, there is shown a graph 300 which shows the definition of the band brake torque controllability which is evaluated with respect to a desired target torque profile 310. Specifically, a deviation 312 of the actually measured brake torque profile 314 from a target torque profile 310 is integrated over the first half 316 and second half 318 of brake band engagement, respectively, and normalized as a “controllability rating”. Mathematically the controllability rating is described as:

Controllability rating (first half of engagement)

$$\begin{matrix}Controllability rating \\ ( first half of engagement )\end{matrix} = \frac{{\int }_{{t}_{0}}^{{t}_{1}} \vert f ( t ) - g ( t ) \vert ⅆ t}{{\int }_{{t}_{0}}^{{t}_{1}} g ( t ) ⅆ t} \times 100 ( \% )$$

Controllability rating (Second half of engagement)

$$\begin{matrix}Controllability rating \\ ( Second half of engagement )\end{matrix} = \frac{{\int }_{{t}_{1}}^{{t}_{2}} \vert f ( t ) - g ( t ) \vert ⅆ t}{{\int }_{{t}_{1}}^{{t}_{2}} g ( t ) ⅆ t} \times 100 ( \% )$$

moreover, “f(t)” is equal to the measured brake torque profile 314 and “g(t)” is equal to the target torque profile 310, which is defined through:

g(t)=kh(t)

and

$$k = \{ \begin{matrix}R ( {ⅇ}^{μ a} - 1 ) ( for energized engagemnt ) \\ R ( 1 - {ⅇ}^{- μ a} ) ( for de \text{-} energized engagemnt )\end{matrix}$$

where “h(t)” is equal to the actuator force profile exerted onto the brake band, “t” is equal to the time, “R” is equal to the drum radius, “a” is equal to the band wrap angle, and “μ” is an evaluation constant which is typically chosen between 0.12 and 0.15. A smaller value of the controllability rating indicates that the band brake torque profile follows the target torque profile more closely, indicating relatively desirable overall controllability. A “variability rating” is defined as a variation of controllability ratings obtained from repeated brake torque measurements under a specified operating condition.

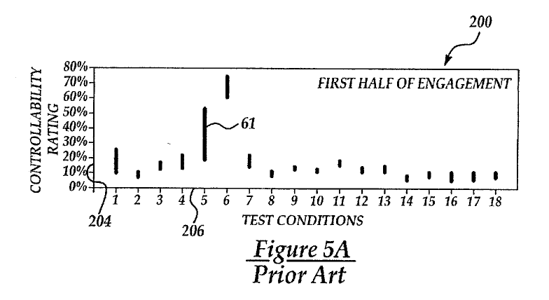

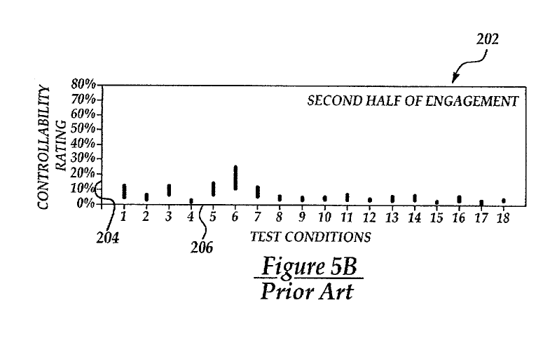

FIGS. 5(a-b) show controllability ratings for the conventional band depicted in FIG. 3(a) for the first half and second half of the engagement, respectively. Particularly, brake torque profiles were repeatedly measured on an industry standard SAE#2 test stand 10 times under each of eighteen test conditions which are set forth in Table 1.

TABLE 1

| | | Oil flow rate | Initial drum speed |
|---|---|---|---|
| Condition No. | Oil Temperature (° F.) | (gallon/min) | (rpm) |
| 1 | 100 | 0.1 | 2000 |
| 2 | 100 | 0.1 | 3700 |
| 3 | 100 | 0.5 | 2000 |
| 4 | 100 | 0.5 | 3700 |
| 5 | 100 | 1.0 | 2000 |
| 6 | 100 | 1.0 | 3700 |
| 7 | 200 | 0.1 | 2000 |
| 8 | 200 | 0.1 | 3700 |
| 9 | 200 | 0.5 | 2000 |
| 10 | 200 | 0.5 | 3700 |
| 11 | 200 | 1.0 | 2000 |
| 12 | 200 | 1.0 | 3700 |
| 13 | 250 | 0.1 | 2000 |
| 14 | 250 | 0.1 | 3700 |
| 15 | 250 | 0.5 | 2000 |
| 16 | 250 | 0.5 | 3700 |
| 17 | 250 | 1.0 | 2000 |
| 18 | 250 | 1.0 | 3700 |

Each graph 200, 202 has a respective first axis 206 which denotes the test condition and a second axis 204 which denotes the controllability rating. The mid point and the length of each bar 61 indicate controllability and variability ratings, respectively, during repeated engagements under a specified test condition. As seen in graph 200, during the first half of the engagement, there is a significant deviation of bar locations, together with a large bar length, from the first axis 206 under several conditions, indicating relatively poor torque controllability and large torque variability during repeated engagements. Furthermore, the controllability ratings vary largely from one condition to another, indicating significantly different torque profiles under different operating conditions. As seen in graph 202, during the second half of the engagement, the controllability ratings are still larger than 10% with relatively large variability (i.e., a large bar length) under several test conditions. Hence, overall, the conventional brake band 210 provides a relatively inconsistent breaking force each time the brake band 210 is compressed by a certain amount under relatively steady band operating conditions. It also provides a relatively inconsistent breaking force each time the brake band 210 is compressed by a certain amount under varying operating conditions. Inconsistent brake force profiles cause inconsistent output shaft torque profiles and undesirable inconsistency in shift feel during gear ratio changing.

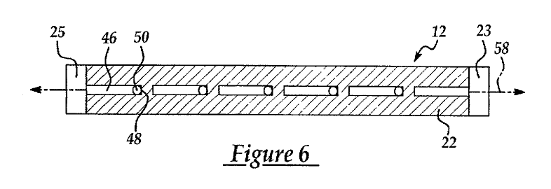

In the preferred embodiment of the invention and as is best shown in FIG. 6, the brake band engagement surface 22 of brake band 12 includes at least one groove 46 having a first end 48 into which an aperture 50 is disposed. In the most preferred embodiment of the invention, the at least one groove 46 is substantially disposed along the longitudinal axis of symmetry 58 of the brake band 12 and has a longitudinal axis of symmetry which resides upon the longitudinal axis of symmetry 258. Further, the at least one groove 46 may have a substantially rectangular shape or substantially any other desired shape. The aperture 50 may be generally round or have substantially any other desired shape.

Hence, as shown in FIG. 1, as the actuator 18 moves in the direction of arrow 24 and as the drum rotates in the same direction 29, commonly referred to as “energizing drum direction,” the contained oil is made to be captured by and travel within the at least one groove 46 and to be communicated to the aperture 50, effective to cause the captured oil 40 to exit the brake band 12 and to be communicated back to the oil reservoir (not shown).

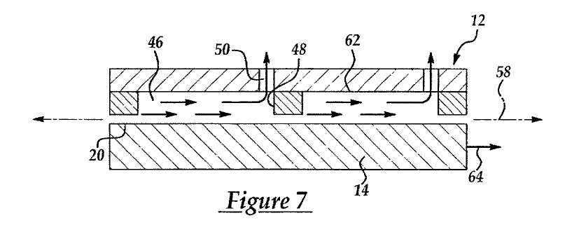

Referring now to FIG. 7, there is shown a side view of a brake band 12 which is shown in FIG. 6, and which is made in accordance with the teachings of the preferred embodiment of the invention. As shown, the brake band engagement surface 22 includes at least one groove 46 having a first end 48 into which an aperture 50 is disposed. FIG. 7 further illustrates the oil flow 40 within the grooves 46 which are between the band steel strap surface 62 and the drum surface 20. In the most preferred embodiment of the invention, the at least one groove 46 is substantially disposed along the longitudinal axis of symmetry 58 of the brake band 12. As the drum 14 turns in the direction of the arrow 64, its sliding surface 20 displaces the oil in the same sliding direction 64 during the band engagement. Particularly, in FIG. 7, the unique placement of the aperture 50 at the very end of the groove 46 allows the groove 46 to capture and readily communicate the captured oil 40 to the aperture 50 and causes substantially all of the oil 40, which is deposited upon the surface 22 prior to and during the band brake engagement, to be removed, thereby allowing the brake band 12 to provide a consistent amount of braking torque to the drum member 14 for each substantially identical amount of force provided by the actuator 18 under different band operating conditions, including varying oil flow, oil temperature, and drum rotational speed. Various numbers of such groove and aperture combinations may be provided along the brake band 12.

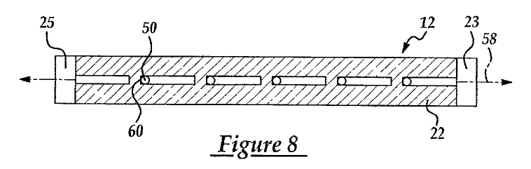

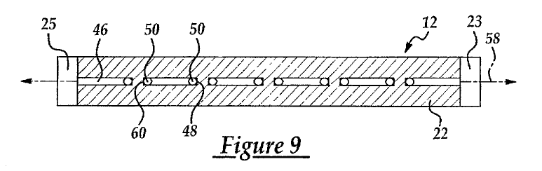

In a second embodiment of the invention, which is shown in FIG. 8, the aperture 50 is placed at end 60 which is opposite to the end 48. This second configuration is used if the drum rotates in the opposite direction of the arrow 29 in FIG. 1, which is commonly referred to as “de-energizing drum direction.” In a third embodiment of the invention, which is shown in FIG. 9, the at least one groove 46 includes an aperture 50 at each opposed end 48, 60 so that the lubricant 40 can be consistently drained when the drum rotates in either energized or de-energized direction.

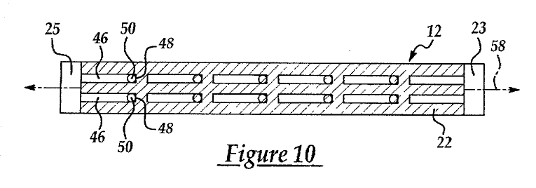

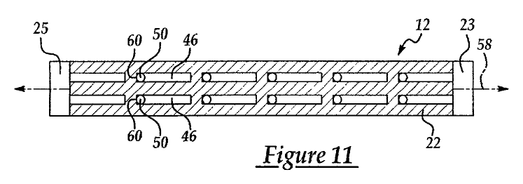

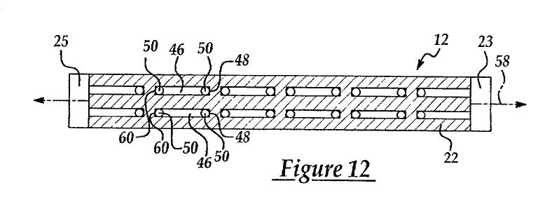

In a fourth embodiment of the invention, which is shown in FIG. 10, at least two grooves 46 are formed upon the engagement surface 22, each of the at least two grooves 46 having a respective longitudinal axis of symmetry and respectively residing upon an axis which is linearly coextensive to axis 58 and being on an opposite side of and substantially equidistant from the longitudinal axis of symmetry 58. Each groove 46 includes an aperture 50 at respective end 48 to drain oil consistently when the drum rotates in an energizing direction. The fifth embodiment of the invention, which is shown in FIG. 11, is substantially identical to the fourth embodiment of the invention with the exception that each of the grooves 46 has an aperture 50 located at respective ends 60 when the drum rotates in a de-energizing direction. The sixth embodiment of the invention, which is shown in FIG. 12, is substantially identical to the fourth embodiment of the invention, with the exception that each of the grooves 46 has an aperture 50 located at respective end 48 and respective end 60 to drain oil consistently when the drum rotates in either energizing or de-energizing direction.

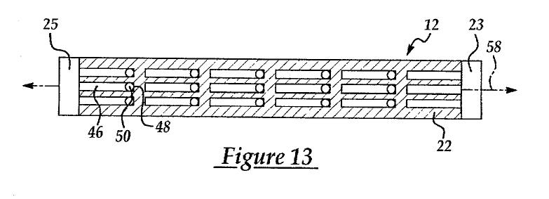

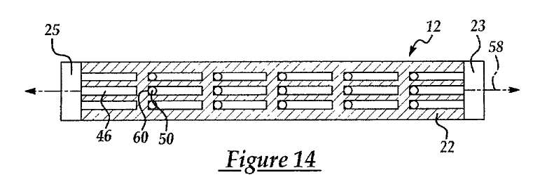

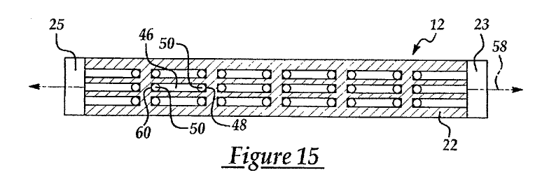

In a seventh embodiment of the invention, which is best shown in FIG. 13, at least one groove 46 having an aperture 50 located at end 48 is disposed along the longitudinal axis 58 and at least a second and a third groove 46, each having an aperture 50 located at respective end 48 to drain oil consistently when the drum rotates in an energizing direction, are located at and are substantially equidistant from the axis 58. The second and third grooves 46 respectively have a longitudinal axis of symmetry and respectively reside upon a respective axis which is substantially and linearly coextensive to the longitudinal axis of symmetry 58. The eighth embodiment, which is best shown in FIG. 14, is substantially identical to the seventh embodiment with the exception that each of the grooves 46 has an aperture 50 located at respective ends 60 to drain oil consistently when the drum rotates in an de-energizing direction. The ninth embodiment, which is shown best in FIG. 15, is substantially similar to the seventh embodiment with the exception that each of the grooves 46 has an aperture 50 located at respective ends 48 and 60 to drain oil consistently when the drum rotates in either energizing or de-energizing direction. It should be realized that other patterns or deployments of “aperture containing grooves” 46 may be made upon the surface 22 and that nothing in this description is meant to limit the invention to the patterns shown in FIGS. 6 and 8-15.

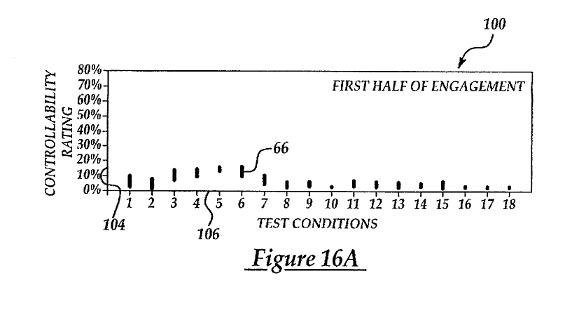

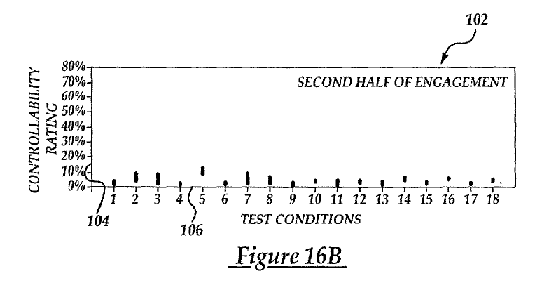

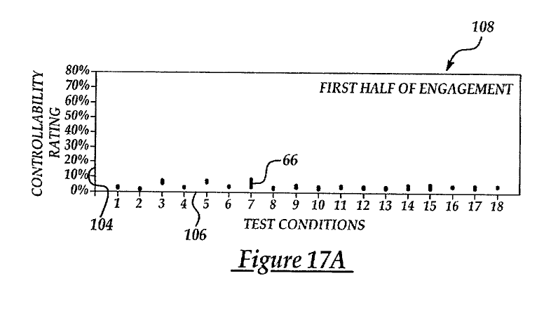

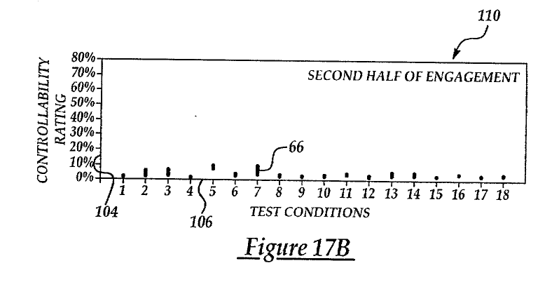

The efficacy of the invention is best illustrated in graphs 100, 102, 108, and 110 which are respectively shown in FIGS. 16(a), 16(b), 17(a), and 17(b). Particularly, data associated with the brake band 12 which is shown in FIG. 6 is illustrated in FIGS. 16 (a-b) and data associated with the brake band 12 which is shown in FIG. 10 is illustrated in FIGS. 17 (a-b). These brake bands were tested under the eighteen test conditions which are set in Table 1.

Each graph 100, 102, 108, and 110 has a respective first axis 106 which denotes the test condition and a respective second axis 104 which denotes the controllability rating, each of which have been previously defined. As seen, the midpoint of each bar 66 which indicates torque controllability is much closer to the first axis 106 compared with the respective bars 66 of graphs 200 and 202, indicating relatively superior torque controllability compared with the conventional brake band in both first and second halves of band engagement. The bar lengths in graphs 100, 102, 108, and 110 are measurably shorter compared with the bar lengths shown in graphs 200 and 202, indicating significantly less torque variability under each test condition. Furthermore, there is very little variation of both controllability and variability across the entire test conditions, indicating consistent torque profiles under different operating conditions. Hence, the brake band 12 provides a substantially consistent breaking force each time the bending band 12 is compressed by a certain amount repeatedly under steady operating conditions or under varying conditions.

It is to be understood that the invention is not limited to the exact construction and method which has been delineated above, but that various changes and modifications may be made without departing from the spirit and the scope of the inventions as are more fully delineated in the following claims.

1. A brake band comprising an engagement surface having at least one groove; and an aperture which is positioned at a first end of said at least one groove, thereby allowing the brake band to consistently provide a desired amount of braking force.

2. The brake band of claim 1 wherein said engagement surface is generally flat.

3. The brake band of claim 2 further comprising at least a second aperture which is disposed upon a second end of said at least one groove.

4. The brake band of claim 2 wherein said at least one groove has a substantially rectangular shape.

5. The brake band of claim 4 wherein said aperture has a substantially round shape.

6. The brake band of claim 2 wherein engagement surface has a longitudinal axis of symmetry and wherein said at least one groove has a longitudinal axis of symmetry which resides upon said longitudinal axis of symmetry of said engagement surface.

7. A brake band comprising an enagement surface having a first plurality of grooves which are disposed upon a certain axis and a second plurality of grooves which are disposed upon a certain second axis, said brake band further having a first plurality of apertures and a second plurality of apertures, each of said first plurality of apertures being disposed upon an end of a unique one of said first plurality of grooves and each of said second plurality of apertures being disposed upon an end of a unique one of said second plurality of grooves.

8. The brake band of claim 7 wherein each of said first and second plurality of grooves are substantially identical.

9. The brake band of claim 8 wherein each of said first and second plurality of apertures are substantially identical.

10. The brake band of claim 9 wherein each of said first and second plurality of grooves has a substantially rectangular shape and wherein each of said first and second plurality of apertures having a substantially round shape.

11. The brake band of claim 7 wherein said engagement surface has a longitudinal axis of symmetry and wherein said first axis is substantially and linearly coextensive to said longitudinal axis of symmetry of said engagement surface.

12. The brake band of claim 11 wherein said second axis is substantially and linearly coextensive to said longitudinal axis of symmetry and wherein said longitudinal axis of symmetry occurs between said first and said second axes.

13. The brake band of claim 11 further comprising a third plurality of grooves which are disposed upon said longitudinal axis of symmetry and a third plurality of apertures, each of said third plurality of apertures being disposed upon an end of a unique one of said plurality of grooves.

14. The brake band of claim 13 wherein each of said third plurality of grooves is substantially identical to each of said first and second plurality of grooves.

15. The brake band of claim 14 wherein each of said third plurality of apertures is substantially identical to each of said first and second plurality of apertures.

16. The brake band of claim II further comprising a fourth plurality of apertures which are each respectively disposed upon a second end of a unique one of said first plurality of grooves.

17. The brake band of claim 11 further comprising a fifth plurality of apertures which are each respectively disposed upon a second end of a unique one of said second plurality of grooves.

18. A method of forming a brake band comprising the steps of forming a generally planar member having a first and a second end, said generally planar member having a longitudinal axis of symmetry; forming a plurality of grooves within a surface of said first member; and forming an aperture within one end of each of said plurality of grooves.

19. The method of claim 18 forming each of said plurality of grooves along a certain axis which is linearly coextensive to said longitudinal axis of symmetry.

20. The method of claim 19 wherein each of said plurality of grooves is substantially identical.
